(19) United States
(12) Patent Application Publication
(10) Pub. No.: US 2022/0064766 A1
(43) Pub. Date: Mar. 3, 2022

(54) BOLT, AND STEEL MATERIAL FOR BOLTS

(71) Applicant: NIPPON STEEL CORPORATION, Chiyoda-ku, Tokyo (JP)

(72) Inventors: Shingo YAMASAKI, Chiyoda-ku, Tokyo (JP); Miyuri UMEHARA, Chiyoda-ku, Tokyo (JP); Toshiyuki MANABE, Chiyoda-ku, Tokyo (JP)

(21) Appl. No.: 17/418,247

(22) PCT Filed: Feb. 7, 2020
(86) PCT No.: PCT/JP2020/004916

§ 371 Date: Jun. 25, 2021

(30) Foreign Application Priority Data
Feb. 8, 2019 (JP) 2019-021904

(51) Int. Cl. C22C 38/46; C22C 38/44; C22C 38/42; C22C 38/32; C22C 38/28; C22C 38/26; C22C 38/06; C22C 38/04; C22C 38/02; C22C 38/00; C21D 6/00; F16B 35/00

(52) U.S. Cl. CPC C22C 38/46; F16B 35/00; C22C 38/42; C22C 38/32; C22C 38/28; C22C 38/26; C22C 38/06; C22C 38/04; C22C 38/02; C22C 38/005; C22C 38/002; C21D 6/008; C21D 6/005; C21D 6/004; C22C 38/44

(57) ABSTRACT

Provided are a bolt that exhibits excellent delayed fracture resistance at a high strength level of from 1,200 MPa to less than 1,600 MPa in tensile strength, where the possibility of delayed fracture is generally quite high, and a steel material for a bolt to be used as the material for such a bolt. The bolt has a composition satisfying Formulae (1) and (2), and a tensile strength of from 1,200 MPa to less than 1,600 MPa. In Formula (1) and Formula (2), Mo and V represent the contents (% by mass) of Mo and V contained in the steel for a bolt, respectively.

0.48≤Mo/1.4+V<1.10 (1)

0.8<Mo/V<3.0 (2)

### TECHNICAL FIELD

The present disclosure relates to a bolt, and a steel material for a bolt.

### BACKGROUND ART

With the increasing performance of automobiles and industrial machines, the weight reduction of automobiles and industrial machines, and the increasing size of civil engineering and construction structures, there is a demand for bolts with higher strength.

Alloy steels for machine structural use such as SCM₄₃₅ and SCM₄₄₀ specified in JIS G 4053:2016 are used for bolts. The strength of bolts is adjusted by quenching-tempering treatment after forming an alloy steel for machine structural use into a prescribed shape.

An increased strength of bolts may be achieved by increasing the carbon content of steel materials, or lowering the tempering temperature.

However, delayed fracture, a kind of hydrogen embrittlement, is a problem for bolts with a tensile strength exceeding 1,200 MPa. Delayed fracture is a phenomenon in which a component under static stress suddenly fractures in a brittle manner after a certain period of time.

Delayed fracture is a phenomenon caused by hydrogen penetration, and the higher the strength of a steel material, the lower the critical value of hydrogen penetration amount that leads to delayed fracture.

When bolts are used outdoors, especially in environments where seawater, snow-melting salt, or the like comes in, the hydrogen penetration amount increases due to salt adhesion, and the possibility of delayed fracture increases.

To address such issues, bolts with excellent delayed fracture resistance have been studied up to now.

For example, Patent Document 1 discloses a bolt and a steel material with excellent delayed fracture resistance having a tensile strength of from 1,200 to 1,600 MPa, taking advantage of V carbonitrides that act as hydrogen trapping sites.

Patent Document 2 discloses a steel for a high tensile strength bolt with excellent delayed fracture resistance having a tensile strength of 125 kgf/mm² or more.

Patent Document 3 discloses a method for manufacturing a high strength bolt having a tensile strength of 1,600 MPa or more with excellent delayed fracture resistance that advantageously prevents hydrogen embrittlement represented by delayed fracture.

Patent Document 4 discloses a high strength steel with excellent delayed fracture resistance that further prevents hydrogen embrittlement represented by delayed fracture, which appears as the strength of a steel material increases, and a high strength bolt made of the high strength steel.

Patent Document 1: Japanese Patent Application Laid-Open (JP-A) No. 2002-276637

Patent Document 2: Japanese Patent Application Laid-Open (JP-A) No. H07-278735

Patent Document 3: Japanese Patent Application Laid-Open (JP-A) No. 2007-31736

Patent Document 4: Japanese Patent Application Laid-Open (JP-A) No. 2013-104070

### SUMMARY OF INVENTION

### Technical Problem

Recently, there has been a demand for bolts with even higher delayed fracture resistance than those of bolts in Patent Documents 1 to 4.

Therefore, an object of the present disclosure is to provide a bolt that exhibits excellent delayed fracture resistance at a strength level of from 1,200 MPa to less than 1,600 MPa in tensile strength, where the possibility of delayed fracture is generally quite high, and a steel material for a bolt to be used as the material for such a bolt.

### Solution to Problem

The inventors have found that an MC-type carbide, which serves as a trapping site for hydrogen, is dispersed in the bolt by employing, as a bolt, a steel material that has a predetermined chemical composition and in which the contents of Mo and V satisfy the following Formulae (1) and (2).

0.48≤Mo/1.4+V<1.10 (1)

0.80<Mo/V<3.00 (2)

As a result, the inventors have found that a bolt with high strength and excellent delayed fracture resistance can be obtained.

The above-described object is achieved by the following means.

[1] A bolt having a composition including, in terms of % by mass:

C: from 0.35 to 0.45%,

Si: from 0.02 to 0.10%,

Mn: from 0.20 to 0.84%,

Cr: from 0.60 to 1.15%,

V: from 0.30 to 0.50%,

Mo: from 0.25 to 0.99%,

Al: from 0.010 to 0.100%,

N: from 0.0010 to 0.0150%,

P: 0.015% or less,

S: 0.015% or less, and

a balance consisting of Fe and impurities,

wherein the bolt has a tensile strength of from 1,200 MPa to less than 1,600 MPa, and

wherein the composition satisfies the following Formula (1) and the following Formula (2):

0.48≤Mo/1.4+V<1.10 (1)

0.80<Mo/V<3.00 (2)

wherein in Formula (1) and Formula (2), Mo and V represent contents (% by mass) of Mo and V contained in the bolt, respectively.

[2] The bolt according to [1], further including at least one selected from the group consisting of:

Ti: 0.100% or less,

Nb: 0.100% or less,

B: 0.0050% or less,

Ni: 0.20% or less,

Cu: 0.20% or less,

W: 0.50% or less,

REM: 0.020% or less,

Sn: 0.20 or less, and

Bi: 0.10 or less.

[3] The bolt according to [1] or [2], further including at least one selected from the group consisting of:

Pb: 0.05% or less,

Cd: 0.05% or less,

Co: 0.05% or less,

Zn: 0.05% or less,

Ca: 0.02% or less, and

Zr: 0.02% or less.

[4] The bolt according to any one of [1] to [3], wherein 10 or more MC-type carbides per unit area of 0.01 μm² that have a length of 5 nm or more and that contain a total of 70 atomic percent or more of V and Mo relative to M (metal element) are present.

[5] The bolt according to any one of [1] to [4], wherein the bolt exhibits a trapped hydrogen concentration of 3.0 ppm or more after the bolt is subjected to 72 hours of cathodic hydrogen charging at a current density of 0.2 mA/cm² in a solution at room temperature containing 3.0 g of ammonium thiocyanate per 1 L of 3.0% by mass sodium chloride aqueous solution, and then left to stand for 48 hours at room temperature.

[6] The bolt according to any one of [1] to [5], wherein, after the bolt is subjected to cathodic hydrogen charging for 24 hours at a current density of 0.03 mA/cm² in a solution at room temperature containing 3.0 g of ammonium thiocyanate per 1 L of 3.0% by mass sodium chloride aqueous solution, and then subjected to electro plating to prevent hydrogen evaporation and thereafter left to stand for 96 hours, the time that it takes for the bolt to rupture under a constant load that is 0.9 times the tensile strength is 100 hours or more .

[7] A steel material for a bolt that is a material for the bolt according to any one of [1] to [6], the steel material including the composition and the tensile strength of the bolt.

### Advantageous Effects of Invention

According to the present disclosure, a bolt with high strength and exhibiting excellent delayed fracture resistance, and a steel material for a bolt that can be used as the material for such a bolt can be provided.

### DESCRIPTION OF EMBODIMENTS

An exemplary embodiment according to the present disclosure will be described in detail below.

In the present specification, the term “%” for the content of each element in the chemical composition means “% by mass”.

The content of each element in the chemical composition may be expressed as the “elemental content”. For example, the content of C may be expressed as C content.

Any numerical range expressed by “from A to B” means a range that includes the numerical values A and B as the lower and upper limits, respectively.

Any numerical range in a case in which “more than” or “less than” is attached to the numerical value of A or B in the numerical range expressed by “from A to B” means a range that does not include the value as the lower limit or the upper limit.

The term “step” includes not only an independent step, but also a step that is not clearly distinguishable from another step, as long as a desired object of the step is achieved.

[Chemical Composition of Bolt]

The chemical composition of the bolt according to the present embodiment is as follows.

(Essential Elements)

C: from 0.35 to 0.45%

C is an element that improves the strength of a steel and increases the strength of the bolt. When the C content is less than 0.35%, a required strength as the bolt cannot be obtained. On the other hand, when the C content is more than 0.45%, a large amount of alloy carbides are left behind without being dissolved during heating for quenching, resulting in low strength at a predetermined tempering temperature, and the precipitation amount of alloy carbides during tempering is relatively reduced, resulting in low hydrogen trapping capacity.

Therefore, the C content is set to from 0.35 to 0.45%. A preferred C content is from 0.37 to 0.42%, and a more preferred C content is from 0.39 to 0.41%.

Si: from 0.02 to 0.10%

The delayed fracture resistance can be improved by reducing the Si content. In order to increase the delayed fracture resistance, the Si content is set to 0.10% or less. On the other hand, even when the Si content is set to less than 0.02%, the improvement in delayed fracture resistance is saturated, and the cost in the steelmaking process increases.

Therefore, the Si content is set to from 0.02 to 0.10%. A preferred Si content is from 0.02 to 0.08%, and a more preferred Si content is from 0.03% to 0.06%.

Mn: from 0.20 to 0.84%

Mn combines with S to form MnS and prevents S segregation at grain boundaries. MnS also has an effect in terms of improving hardenability. When the Mn content is less than 0.20%, the S segregation at grain boundaries increases, and the delayed fracture resistance decreases. On the other hand, when the Mn content exceeds 0.84%, the cold workability when machining into the shapes of parts lowers, and quenching cracking is more likely to occur.

Therefore, the Mn content is set to from 0.20 to 0.84%. A preferred Mn content is from 0.30 to 0.75%, and a more preferred Mn content is from 0.40 to 0.70%.

Cr: from 0.60 to 1.15%

Cr is an effective element to ensure the hardenability of a steel. When the Cr content is less than 0.60%, the effect in terms of improving hardenability is insufficient. As a result, the strength is insufficient. On the other hand, when the Cr content exceeds 1.15%, the cold workability of the steel is reduced. When the Cr content exceeds 1.15%, a desired hydrogen trapping effect cannot be obtained because cementite is stabilized and the precipitation of MC-type carbides (such as (Mo, V)C) with high hydrogen trapping capacity is inhibited during tempering.

Therefore, the Cr content is set to from 0.60 to 1.15%. A preferred Cr content is from 0.70 to 1.00%, and a more preferred Cr content is from 0.80 to 0.90%.

V: from 0.30 to 0.50%

Mo: from 0.25 to 0.99%

V and Mo are important elements in the present disclosure. V and Mo are elements that form carbides. When an appropriate amount of V is combined with Mo and is included in a steel, MC-type carbides (such as (V, Mo)C), which are carbides containing V and Mo, precipitate. Precipitation of a large number of fine MC-type carbides is enabled by quenching a steel from the austenite region and then tempering the steel at a high temperature of from 550 to 680° C. The precipitation of such fine MC-type carbides can increase the strength of a steel by precipitation hardening. Fine MC-type carbides act as high hydrogen trapping sites compared to VC and M₂C-type carbides (such as Mo₂C), and can improve the delayed fracture resistance. Trapped hydrogen is hydrogen that is fixed by the above-described MC-type carbides and cannot move freely in a steel.

In order to sufficiently obtain MC-type carbides that function as hydrogen trapping sites with high hydrogen trapping capacity, 0.30% or more of V and 0.25% or more of Mo need to be contained. On the other hand, when the V content exceeds 0.50% or the Mo content exceeds 0.99%, coarse carbides which have not dissolved as a solid solution remain during quenching and heating, as a result of which a higher heating temperature for quenching is necessary to dissolve the coarse carbides as a solid solution in austenite, leading to problems such as occurrence of strain during quenching and increase of oxides on the surface.

Accordingly, the V content is set to from 0.30 to 0.50%, and the Mo content is set to from 0.25 to 0.99%. A preferred V content is from 0.32 to 0.45%, a preferred Mo content is from 0.40 to 0.90%, a more preferred V content is from 0.35 to 0.40%, and a more preferred Mo content is from 0.60 to 0.80%.

The V content and the Mo content need to satisfy Formulae (1) and (2).

0.48≤Mo/1.4+V<1.10 (1)

0.80<Mo/V<3.00 (2)

In Formulae (1) and (2), Mo and V represent the Mo content and the V content (% by mass) of a bolt, respectively.

In a bolt with high strength having a tensile strength of 1,200 MPa or more, a large amount of fine MC-type carbides (such as (V, Mo)C), which are high hydrogen trapping sites, need to be dispersed in a steel in order to improve the delayed fracture resistance.

When the value (Mo/1.4+V) in Formula (1) is less than 0.48, MC-type carbides (such as (V, Mo)C) do not sufficiently precipitate, and the hydrogen trapping capacity is insufficient, resulting in lower delayed fracture resistance.

On the other hand, when the value (Mo/1.4+V) in Formula (1) is 1.10 or more, carbides cannot completely dissolve as a solid solution during heating for quenching, and coarse MC-type carbides (such as (V, Mo)C) occur after tempering, resulting in lower delayed fracture resistance.

From the viewpoint of improving the delayed fracture resistance, the value (Mo/1.4+V) in Formula (1) is preferably from 0.60 to 1.00, and more preferably from 0.80 to 0.90.

When the value (Mo/V) in Formula (2) is 0.80 or less, MC-type carbides (such as (V, Mo)C) do not sufficiently precipitate, and the hydrogen trapping capacity is reduced, resulting in lower delayed fracture resistance.

On the other hand, when the value (Mo/V) in Formula (2) is 3.00 or more, M₂C-type carbides (such as Mo₂C) with low hydrogen trapping capacity precipitate instead of MC-type carbides (such as (V, Mo)C), resulting in insufficient hydrogen trapping capacity and lower delayed fracture resistance.

From the viewpoint of improving the delayed fracture resistance, the value (Mo/V) in Formula (2) is preferably from 1.20 to 2.70, and more preferably from 1.70 to 2.50.

Al: from 0.010 to 0.100%

Al is an element that functions as a deoxidizing agent and is also an element that forms a nitride to restrict coarsening of austenite crystal grains during heating for quenching. In order to obtain these effects, 0.010% or more of Al needs to be contained. On the other hand, when the Al content exceeds 0.100%, coarse oxide inclusions remain in a steel and become fracture origins of the bolt. Furthermore, formation of MC-type carbides is suppressed, and the hydrogen trapping effect cannot be obtained. As a result, the delayed fracture resistance deteriorates.

Therefore, the Al content is set to from 0.010 to 0.100%. A preferred Al content is from 0.012 to 0.050%, and a more preferred Al content is from 0.015 to 0.035%.

N: from 0.0010 to 0.0150%

N is an element that forms nitrides or carbonitrides and restricts coarsening of austenite crystal grains during heating for quenching. In order to restrict coarsening of crystal grains, the N content needs to be 0.0010% or more. On the other hand, when the N content exceeds 0.0150%, coarse nitrides or carbonitrides occur and become fracture origins. Furthermore, formation of MC-type carbides is suppressed, and the hydrogen trapping effect cannot be obtained. As a result, the delayed fracture resistance deteriorates.

Therefore, the N content is set to from 0.0010 to 0.0150%. A preferred N content is from 0.0020 to 0.0100%, and a more preferred N content is from 0.0030 to 0.0060%.

P: 0.015% or less

P is an impurity. The P content is preferably as low as possible. P segregates at austenite grain boundaries. When the P content exceeds 0.015%, prior austenite grain boundaries after quenching and tempering embrittles, causing grain boundary cracking. Therefore, the P content needs to be limited to a range of 0.015% or less. The upper limit of a preferred P content is 0.012%. Although P is an impurity element, more than 0% of P may be contained in a bolt as long as the content is within the above-described range.

From the viewpoint of reducing the cost of dephosphorization, the lower limit of the P content may be 0.005% or more.

S: 0.015% or less

S is an impurity. The S content is preferably as low as possible. S is contained as Mn sulfide in a steel. Mn sulfide generates hydrogen sulfide in a chemical reaction during corrosion of the surface of a steel material. When this hydrogen sulfide decomposes to produce hydrogen, the hydrogen enters the steel and reduces the delayed fracture resistance. Furthermore, Mn sulfide serves as a fracture origin. Therefore, the S content needs to be limited to a range of 0.015% or less. The upper limit of a preferred S content is 0.012%. Although S is an impurity element, more than 0% of S may be contained in a bolt as long as the content is within the above-described range.

From the viewpoint of reducing the cost of desulfurization, the lower limit of the S content may be 0.005% or more.

(Optional Elements)

The bolt according to the present embodiment may contain at least one of Ti, Nb, B, Ni, Cu, W, REM, Sn, or Bi as an optional element. Specifically, each of these optional elements may be contained within the range of from 0% to the upper limit of each of the elements described below.

Ti: 0.100% or less

Ti is an element that combines with N and C in a steel material to form a carbonitride. Such a carbonitride prevents coarsening of the microstructure by pinning austenite grain boundaries. In order to obtain such an effect of preventing microstructure coarsening, Ti may be contained in 0.100% or less. On the other hand, when more than 0.100% of Ti is contained, the cold workability when machining into the shapes of parts lowers due to an increase in the material hardness.

Therefore, the Ti content is preferably set to 0.100% or less, more preferably from more than 0% to 0.100%, and still more preferably from 0.005% to 0.050%.

Nb: 0.100% or less

Nb is an element that combines with N and C in a steel material to form carbonitrides. Such carbonitrides prevent coarsening of the microstructure by pinning austenite grain boundaries. In order to obtain such an effect of preventing microstructure coarsening, Nb may be contained in 0.100% or less. On the other hand, when more than 0.100% of Nb is contained, the cold workability when machining into the shapes of parts lowers due to an increase in the material hardness.

Therefore, the Nb content is preferably set to 0.100% or less, more preferably from more than 0% to 0.100%, and still more preferably from 0.005% to 0.050%.

B: 0.0050% or less

B increases the hardenability of a steel even when dissolved in a small amount as a solid solution in austenite. B may be contained in a steel material to efficiently obtain martensite during carburizing and quenching. On the other hand, when the B content exceeds 0.0050%, a large amount of BN is formed while consuming N, and, therefore, austenite grains become coarse.

Therefore, the B content is preferably set to 0.0050% or less, more preferably from more than 0 to 0.0050%, and still more preferably from 0.0007 to 0.0030%.

Ni: 0.20% or less

Ni is an element that increases corrosion resistance and toughness, and may be contained in a bolt. The upper limit of the Ni content is preferably 0.20%, because a large amount of Ni does not provide an effect worth the cost. On the other hand, the lower limit of the Ni content is preferably 0.01%.

Cu: 0.20% or less

Cu is an element that enhances corrosion resistance and may be contained in a bolt. On the other hand, when the Cu content exceeds 0.20%, the hot ductility of a steel material for a bolt decreases, and therefore the upper limit of the Cu content is preferably 0.20%. On the other hand, the lower limit of Cu content is preferably 0.01%.

W: 0.50% or less

W, like Mo, is an element that causes noticeable secondary hardening when tempered at high temperatures. W precipitates as MC-type carbides ((V, Mo, W)C) and can increase the strength of a steel by precipitation hardening. Furthermore, MC-type carbides containing W can function as hydrogen trapping sites with high hydrogen trapping capacity and can improve the delayed fracture resistance.

Therefore, the W content is preferably set to 0.50% or less, more preferably from more than 0 to 0.30%, and still more preferably from 0.10 to 0.20%.

REM: 0.020% or less

REM (rare earth element) is a generic term for a total of 17 elements: 15 elements from lanthanum with atomic number 57 to lutetium with atomic number 71, scandium with atomic number 21, and yttrium with atomic number 39. When REM is contained in a bolt, elongation of MnS particles is restricted during rolling and hot forging of a steel material for a bolt, and an effect of reducing cracking during cold forging is obtained. However, when the REM content exceeds 0.020%, a large amount of sulfides including REM are formed, and the machinability of a steel material for a bolt deteriorates.

Therefore, the REM content in total of the 17 elements described above is preferably set to 0.020% or less, more preferably from more than 0% to 0.020%, and still more preferably from 0.001% to 0.010%.

Sn: 0.10 or less

Sn is an element that enhances corrosion resistance and may be contained in a bolt. When a large amount of Sn is contained, the high temperature ductility decreases, and the risk of cracking during casting increases, and therefore the upper limit of the Sn content is preferably 0.20%. On the other hand, the lower limit of the Sn content is preferably 0.005%.

Bi: 0.1 or less

Bi is an element that improves workability, and may be contained in a bolt. When a large amount of Bi is contained, the high temperature ductility decreases, and the risk of cracking during casting increases, and therefore, the upper limit of Bi content is preferably 0.10%. On the other hand, the lower limit of Bi content is preferably 0.005%.

(Other Optional Elements)

The bolt according to the present embodiment may contain at least one element selected from the group consisting of the following elements as an optional element. Specifically, each of these optional elements may be contained within the range of from 0% to the upper limit of each of the elements described below. Even when these optional elements are contained in a bolt in the range described below, the properties of the bolt are not affected.
Pb: 0.05% or less
Cd: 0.05% or less
Co: 0.05% or less
Zn: 0.05% or less
Ca: 0.02% or less
Zr: 0.02% or less

The balance of the chemical composition of the bolt according to the present embodiment consists of Fe and impurities. Here, the impurities refer to elements that are mixed in from ores utilized as raw materials for steel, scrap, or the environment during the manufacturing process.

(MC-type carbide)

The bolt according to the present embodiment preferably contains 10 or more MC-type carbides having a length of 5 nm or more, per unit area of 0.01 μm².

Fine plate-shaped MC-type carbides that precipitate during a tempering step have a higher hydrogen trapping capacity than that of VC and M₂C-type carbides (such as Mo₂C), and contribute to improving delayed fracture resistance.

Here, the fine MC-type carbides are MC-type carbides that contain a total of 70 atomic percent or more of V and Mo relative to M (metal element). Specific examples of the fine MC-type carbides include (V, Mo)C and (V, Mo, W)C. These MC-type carbides have a higher hydrogen trapping capacity than that of VC and M₂C-type carbides (such as Mo₂C), and contribute to the improvement of delayed fracture resistance.

Therefore, MC-type carbides with a length of 5 nm or more are preferably contained in a predetermined amount.

Therefore, the number density of MC-type carbides with a length of 5 nm or more (the number of MC-type carbides with a length of 5 nm or more contained per unit area of 0.01 μm²) is preferably 10 or more.

From the viewpoint of improving delayed fracture resistance, the number density of MC-type carbides is more preferably 15 or more per unit area of 0.01 μm², and still more preferably 20 or more per unit area of 0.01 μm².

However, the upper limit of the number density of MC-type carbides is, for example, 100 or less per unit area of 0.01 μm², from the viewpoint of curbing a decrease in elongation and toughness.

For measuring the number density of MC-type carbides, a thin film test piece is prepared by a thin film method and transmission electron microscopy is used.

Determination of the composition of MC-type carbides is performed by preparing a test piece by an extraction replica method and using a transmission microscope (TEM) with an energy dispersive X-ray analyzer (EDS).

Specifically, the following procedure is used.

From a freely-selected location of a bolt to be measured, a portion having a plane (hereinafter also referred to as the “measurement plane”) that is located at a depth of 2 mm from the surface of the bolt and parallel to the surface of the bolt is sampled, and a thin film test piece is prepared by a thin film method and a test piece is prepared by an extraction replica method.

Here, the preparation of a thin film test piece by a thin film method is performed as follows. First, the material as sampled is cut to obtain a 0.5 mm-thick piece using a precision cutting machine. Next, the piece is machined and polished to a thickness of 60 μm from both sides using an emery paper of P320-1200, and a specimen of 3 mmΦ (diameter) is punched out. After that, jet electropolishing is performed on both sides until a hole is made in the center of the piece to obtain a thin film test piece for TEM observation. The electropolishing is performed with TenuPol, and 100 ml perchloric acid-800 ml glacial acetic acid solution-100 ml methanol is used as the electropolishing solution, and the electropolishing conditions are set at 30 V and 0.1 A.

The preparation of a test piece by an extraction replica method is performed as follows. First, the measurement plane of the specimen sampled from the steel member is electropolished. After electropolishing, the measurement plane of the specimen is subjected to constant potential electrolysis at a potential of −200 mV using a 10% acetylacetone-1% tetramethylammonium chloride (TMAC)-methanol solution. As a result of this, MC-type carbides are exposed to stick out from the measurement plane of the specimen. The energizing time is from 30 to 60 sec.

An acetylcellulose film is attached to the measurement plane of the specimen after electrolysis, and then the film is peeled off so that the MC-type carbides are transferred onto the film. Carbon vapor deposition is performed on the transferred film to prepare a carbon vapor deposited film. The carbon vapor deposited film is immersed in a methyl acetate solution to dissolve the acetylcellulose film, and then scooped up with a Cu mesh of 3 mm in diameter to obtain an extraction replica film (test piece by the extraction replica method).

Next, the number density of MC-type carbides is measured as follows. The direction perpendicular to the {001} plane of the iron matrix is used as the incident direction of electron beam, and three freely-selected fields of view of the thin film test piece (the measurement plane) are observed at a magnification of 400,000 times (observation area of 0.25 μm×0.25 μm). MC-type carbides were identified by electron diffraction pattern analysis. Subsequently, the lengths and number of all MC-type carbides present in an area of 0.1 μm×0.1 μm at the central part of the observation screen are measured, the number of MC-type carbides with a length of 5 nm or more is measured, and the average value thereof over five fields of view is determined as the “number density of MC-type carbides.

Here, the length of a MC-type carbide means the maximum length of the MC-type carbide observed.

TEM observation is performed by FE-TEM at an acceleration voltage of 200 kV.

The chemical composition of MC-type carbides is measured as follows. A freely-selected field of view (a view field of an observation area of 0.5 μm×0.5 μm) of the extraction replica film (the measurement plane) as a test piece is observed at a magnification of 200,000 times. The MC-type carbides are identified by analysis of TEM electron diffraction patterns and EDS analysis of the components of precipitates present in the field of view to be observed, and the atomic % of metallic elements in the carbides is measured by EDS analysis. The number of MC-type carbide grains to be measured is set at five, and the average over these grains is used as the metallic element concentration.

TEM electron diffraction pattern analysis and EDS analysis are performed by FE-TEM at an acceleration voltage of 200 kV.

(Tensile Strength)

In the bolt according to the present embodiment, the tensile strength measured by sampling a tensile test piece from the bolt is from 1,200 MPa to less than 1,600 MPa. When the tensile strength is 1,200 MPa or higher, the bolt can be made smaller and lighter. On the other hand, when the tensile strength exceeds 1,600 MPa, the possibility of delayed fracture increases even when the amount of hydrogen penetration is small.

Therefore, the tensile strength of the bolt is set to from 1,200 MPa to less than 1,600 MPa.

The tensile strength of a bolt is a value measured in accordance with JIS Z 2241:2011.

The tensile strength of a bolt is measured by sampling a test piece from the bolt as follows.

From the bolt shaft, a No. 14A test piece of which the diameter of the parallel part thereof is 50% of the bolt diameter is cut out, and a tensile test is performed in the atmosphere at room temperature (25° C.) to obtain the tensile strength.

(Trapped Hydrogen Concentration)

The bolt according to the present embodiment preferably exhibits a trapped hydrogen concentration of 3.0 ppm or more after being subjected to 72 hours of cathodic hydrogen charging at a current density of 0.2 mA/cm² in a solution at room temperature (25° C.) containing 3.0 g of ammonium thiocyanate per 1 L of 3.0% by mass sodium chloride aqueous solution, and then left to stand for 48 hours at room temperature (25° C.). When the trapped hydrogen concentration is less than 3.0 ppm, the hydrogen that has entered the bolt may diffuse and accumulate at prior austenite grain boundaries, increasing the possibility of delayed fracture. Therefore, the trapped hydrogen concentration is preferably 3.0 ppm or more.

The trapped hydrogen concentration is measured by a thermal desorption analysis method of hydrogen using a gas chromatograph. The amount of hydrogen released from a sample from room temperature (25° C.) to 400° C. at a temperature rise rate of 100° C./hour is defined as the trapped hydrogen concentration.

The measurement of the trapped hydrogen concentration is performed on a round bar test piece (round bar test piece for investigating the trapped hydrogen concentration) of 7 mm in diameter and 70 mm in length taken from the bolt.

When a round bar test piece of the above-described size cannot be taken, a round bar test piece with a diameter of 5 mm and a length of 20 mm may be used instead, and the concentration of hydrogen trapped may be measured by performing the same hydrogen charging and standing still, and the same thermal desorption analysis method.

(Delayed Fracture Resistance)

The bolt according to the present embodiment is preferably provided with sufficient delayed fracture resistance for use in a real environment. After the bolt according to the present embodiment is subjected to cathodic hydrogen charging for 24 hours at a current density of 0.03 mA/cm² in a solution at room temperature (25° C.) containing 3.0 g of ammonium thiocyanate per 1 L of 3.0% by mass sodium chloride aqueous solution, and then subjected to electro plating to prevent hydrogen evaporation and thereafter left to stand for 96 hours, the time that it takes for the bolt to rupture under a constant load that is 0.9 times the tensile strength is preferably 100 hours or more. Here, electro plating to prevent hydrogen evaporation is performed to trap hydrogen in a steel material, and hot dip galvanizing is used.

The measurement of delayed fracture resistance is performed on a round bar test piece having a diameter of 7 mm and a length of 70 mm taken from a bolt and having a notch (notch diameter 4.2 mm, angle 60°) (delayed fracture test piece).

When a round bar test piece of the above-described size cannot be taken, a round bar test piece having a diameter of 5 mm and having a notch (notch diameter 3.0 mm, angle 60°) may be used instead. There is no restriction on the length, as long as the test piece can be chucked.

<Steel Material for Bolt >

The steel material for a bolt according to the present embodiment is a steel material that is used as a material for the bolt according to the present embodiment. The steel material for a bolt according to the present embodiment has the same chemical composition and tensile strength as those of the bolt according to the present embodiment.

The tensile strength of a steel material for a bolt is measured in the same manner as the tensile strength of a bolt.

<Method for Manufacturing Bolt >

The following is a detailed description of an example of the method for manufacturing a bolt according to the present embodiment, using the steel material for a bolt according to the present embodiment.

(Step of Forming into Bolt Shape)

After obtaining a molten steel having the bolt chemical composition according to the present embodiment, the molten steel is made into an ingot or a cast piece by casting. The cast ingot or cast piece is then finished into a steel material with a required basic shape, such as a round bar, by hot working such as hot rolling, hot extrusion, or hot forging. Subsequently, the steel material is subjected to wire drawing, annealing, cold working, thread rolling, and the like, thereby being formed into a predetermined bolt shape. Between plural times of cold working, plural times of annealing or spheroidizing annealing treatment may be performed. Furthermore, hot working can also be included in the forming step.

(Steps of Quenching and Tempering)

After forming into the predetermined bolt shape, the steel is heated to a temperature higher than austenitization and then quenched by water cooling or oil cooling to add strength.

When heating temperature (hereinafter, referred to as the “quenching heating temperature”) for quenching is too low, dissolving of fine MC-type carbides (such as (Mo, V)C) with a high hydrogen trapping capacity as a solid solution in a matrix is insufficient, and coarse carbides remain. As a result, the amount of fine MC-type carbides (such as (Mo, V)C) that will precipitate during tempering decreases, and a desired strength and hydrogen trapping effect cannot be obtained. As a result, the delayed fracture resistance deteriorates.

On the other hand, an excessively high quenching heating temperature is not preferable because such a temperature leads to coarsening of crystal grains, deterioration of toughness and delayed fracture resistance, and also increases manufacturing costs by causing noticeable damage to a furnace body and accessory parts of an operating heat treatment furnace.

Therefore, the quenching heating temperature is preferably set to from 900 to 960° C. The retention time at the quenching heating temperature is preferably set to from 30 to 90 minutes.

For improving the delayed fracture resistance, tempering needs to be performed after the above-described quenching treatment. In the present disclosure, the tempering temperature needs to be limited to from 550 to 690° C.

When the tempering temperature is less than 550° C., the temperature is too low and sufficient MC-type carbides cannot be precipitated. Therefore, a desired hydrogen trapping capacity and the critical hydrogen concentration for delayed fracture cannot be achieved, and the delayed fracture resistance deteriorates.

On the other hand, when the tempering temperature is higher than 690° C., MC-type carbides exhibit Ostwald ripening, and the hydrogen trapping capacity is considerably reduced. Therefore, a desired hydrogen trapping capacity and the critical hydrogen concentration for delayed fracture cannot be achieved, and the delayed fracture resistance deteriorates.

Therefore, the tempering temperature is limited to from 550 to 690° C. A preferred range of tempering temperature is from 580 to 660° C.

The retention time at the tempering temperature is preferably set to from 30 to 90 minutes, and the tempering cooling rate is preferably set to from 50 to 100° C./s.

The above steps are used to manufacture the bolt according to the present embodiment.

As described above, the bolt according to the present embodiment is designed to achieve a suitable tensile strength, trapped hydrogen concentration, and critical hydrogen concentration for delayed fracture by subjecting a steel material for a bolt having an optimum chemical composition to optimum quenching and tempering.

### EXAMPLES

Next, Examples of the present disclosure will be described. Each of the conditions described below is only one example adopted to confirm the operability and effect according to the present disclosure, and the conditions of the present disclosure are not limited to this one example. In implementing the present disclosure, a variety of conditions may be adopted as long as such conditions achieve an object of the present disclosure without departing from the gist thereof.

<Forming of Test Pieces >

(Preparation of Steel Bar)

Steels (steels Nos. A to AQ) with the chemical compositions listed in Table 1-1 and Table 1-2 were melted and hot forged to prepare steel bars with a diameter of 20 mm and a length of 1,000 mm. The underlined values in Table 1-1 and Table 1-2 indicate that the values are outside the ranges specified in the present disclosure. The sign “-” in Table 1-1 and Table 1-2 indicates that the corresponding element is not contained, and the blank column indicates that other optional elements are not contained.

In the chemical compositions listed in Table 1-1 and Table 1-2, oxygen (0) is an element contained as an impurity in a steel.

TABLE 1-1

| Steel | Component composition (% by mass) | | | | | | | | | | | |
|---|---|---|---|---|---|---|---|---|---|---|---|---|
| No. | C | Si | Mn | Cr | Mo | V | P | S | Al | N | Ti | Nb |
| A | 0.40 | 0.07 | 0.46 | 0.62 | 0.99 | 0.35 | 0.010 | 0.009 | 0.025 | 0.0036 | — | 0.024 |
| B | 0.41 | 0.05 | 0.41 | 1.00 | 0.70 | 0.35 | 0.010 | 0.008 | 0.024 | 0.0038 | — | — |
| C | 0.35 | 0.09 | 0.21 | 0.88 | 0.88 | 0.30 | 0.008 | 0.009 | 0.019 | 0.0012 | — | — |
| D | 0.45 | 0.02 | 0.84 | 0.82 | 0.72 | 0.50 | 0.015 | 0.007 | 0.018 | 0.0041 | — | — |
| E | 0.38 | 0.04 | 0.51 | 1.15 | 0.71 | 0.30 | 0.007 | 0.015 | 0.017 | 0.0148 | 0.025 | — |
| F | 0.37 | 0.05 | 0.65 | 1.10 | 0.25 | 0.30 | 0.004 | 0.009 | 0.012 | 0.0061 | — | — |
| G | 0.41 | 0.10 | 0.39 | 1.05 | 0.71 | 0.36 | 0.010 | 0.008 | 0.091 | 0.0056 | — | — |
| H | 0.40 | 0.05 | 0.43 | 1.00 | 0.50 | 0.35 | 0.010 | 0.008 | 0.024 | 0.0038 | — | — |
| I | 0.40 | 0.05 | 0.43 | 1.00 | 0.50 | 0.35 | 0.010 | 0.008 | 0.024 | 0.0038 | — | — |
| J | 0.40 | 0.05 | 0.43 | 1.00 | 0.50 | 0.41 | 0.010 | 0.008 | 0.024 | 0.0038 | — | — |
| K | 0.40 | 0.05 | 0.45 | 0.95 | 0.50 | 0.41 | 0.010 | 0.008 | 0.024 | 0.0038 | — | — |
| L | 0.40 | 0.06 | 0.45 | 0.95 | 0.30 | 0.30 | 0.010 | 0.008 | 0.024 | 0.0038 | — | — |
| H | 0.40 | 0.05 | 0.43 | 0.96 | 0.48 | 0.36 | 0.003 | 0.008 | 0.025 | 0.0036 | — | — |
| I | 0.39 | 0.06 | 0.41 | 0.85 | 0.50 | 0.31 | 0.005 | 0.008 | 0.026 | 0.0036 | — | — |

| Steel | Component composition (% by mass) | | | | | | | |
|---|---|---|---|---|---|---|---|---|
| No. | B | W | Ni | Cu | REM | Others | Mo/1.4 + V | Mo/V |
| A | — | — | — | — | — | O: 0.0013 | 1.06 | 2.83 |
| B | — | — | 0.01 | 0.01 | — | O: 0.0014 | 0.85 | 2.00 |
| C | — | — | — | — | — | O: 0.0017 | 0.93 | 2.93 |
| D | — | — | — | — | — | Sn: 0.05 | 1.01 | 1.44 |
| | | | | | | O: 0.0015 | | |
| E | 0.0012 | — | — | — | — | O: 000114 | 0.81 | 2.37 |
| F | — | — | 0.01 | 0.01 | — | O: 0.0012 | 0.48 | 0.83 |
| G | — | — | 0.03 | 0.02 | 0.011 | O: 0.0008 | 0.87 | 1.97 |
| H | — | — | 0.01 | 0.01 | — | O: 0.0011 | 0.71 | 1.43 |
| I | — | 0.30 | 0.01 | 0.01 | — | O: 0.0014 | 0.71 | 1.43 |
| J | — | — | 0.05 | 0.04 | — | O: 0.0031 | 0.77 | 1.22 |
| K | — | — | 0.05 | 0.04 | — | O: 0.0027 | 0.77 | 1.22 |
| L | — | — | 0.05 | 0.04 | — | Bi: 0.002 | 0.51 | 1.00 |
| | | | | | | O: 0.0021 | | |
| H | — | — | 0.01 | 0.01 | — | Co: 0.01 | 0.70 | 1.33 |
| | | | | | | Zn: 0.003 | | |
| | | | | | | Ca: 0.005 | | |
| I | — | — | 0.01 | 0.01 | — | Zr: 0.001 | 0.67 | 1.61 |
| | | | | | | Cd: 0.001 | | |
| | | | | | | Pb: 0.002 | | |
| | | | | | | O: 0.0023 | | |

TABLE 1-2

| Steel | Component composition (% by mass) | | | | | | | | | | | |
|---|---|---|---|---|---|---|---|---|---|---|---|---|
| No. | C | Si | Mn | Cr | Mo | V | P | S | AI | N | Ti | Nb |
| AA | 0.37 | 0.05 | 0.33 | 1.03 | 0.80 | 0.39 | 0.011 | 0.004 | 0.055 | 0.0280 | — | 0.040 |
| AB | 0.49 | 0.08 | 0.28 | 0.82 | 0.31 | 0.30 | 0.008 | 0.005 | 0.035 | 0.0044 | — | — |
| AC | 0.38 | 0.06 | 0.39 | 1.15 | 0.88 | 0.30 | 0.008 | 0.009 | 0.198 | 0.0044 | 0.052 | — |
| AD | 0.37 | 0.05 | 0.64 | 1.20 | 0.24 | 0.29 | 0.005 | 0.006 | 0.030 | 0.0038 | — | — |
| AE | 0.45 | 0.01 | 0.52 | 1.02 | 0.35 | 0.21 | 0.008 | 0.004 | 0.041 | 0.0041 | — | 0.005 |
| AF | 0.36 | 0.10 | 0.68 | 0.90 | 0.10 | 0.37 | 0.010 | 0.003 | 0.010 | 0.0025 | — | 0.100 |
| AG | 0.35 | 0.05 | 0.71 | 0.91 | 0.99 | 0.30 | 0.010 | 0.003 | 0.027 | 0.0036 | — | — |
| AH | 0.40 | 0.05 | 0.54 | 1.00 | 1.00 | 0.32 | 0.010 | 0.008 | 0.032 | 0.0034 | — | — |
| AI | 0.42 | 0.05 | 0.75 | 0.83 | 1.10 | 0.40 | 0.003 | 0.004 | 0.030 | 0.0031 | — | — |
| AJ | 0.37 | 0.08 | 0.31 | 1.50 | 0.82 | 0.39 | 0.009 | 0.007 | 0.056 | 0.0029 | — | — |
| AK | 0.35 | 0.06 | 0.34 | 0.18 | 0.31 | 0.30 | 0.008 | 0.008 | 0.044 | 0.0024 | — | — |
| AL | 0.31 | 0.05 | 0.41 | 0.95 | 0.30 | 0.30 | 0.010 | 0.008 | 0.025 | 0.0041 | — | — |
| AM | 0.40 | 0.20 | 0.43 | 0.95 | 0.25 | 0.30 | 0.010 | 0.008 | 0.024 | 0.0038 | — | — |
| AN | 0.35 | 0.05 | 0.41 | 1.00 | 0.50 | 0.61 | 0.010 | 0.008 | 0.024 | 0.0038 | — | — |
| AO | 0.35 | 0.05 | 0.45 | 0.95 | 0.99 | 0.50 | 0.010 | 0.008 | 0.024 | 0.0038 | — | — |
| AP | 0.45 | 0.06 | 1.03 | 0.83 | 0.65 | 0.32 | 0.010 | 0.008 | 0.024 | 0.0038 | — | — |
| AQ | 0.35 | 0.05 | 0.10 | 0.98 | 0.60 | 0.35 | 0.009 | 0.009 | 0.031 | 0.0035 | — | — |
| AR | 0.35 | 0.09 | 0.21 | 0.88 | 0.25 | 0.35 | 0.008 | 0.009 | 0.019 | 0.0012 | — | — |
| AS | 0.40 | 0.06 | 0.41 | 1.31 | 0.40 | 0.33 | 0.005 | 0.007 | 0.082 | 0.0035 | 0.022 | — |
| AT | 0.35 | 0.15 | 0.65 | — | 2.00 | 0.40 | 0.014 | 0.009 | 0.019 | 0.0032 | — | — |
| AU | 0.53 | 2.07 | 1.28 | 1.13 | 0.22 | 0.43 | 0.006 | 0.008 | 0.0026 | 0.0041 | — | — |
| AV | 0.37 | 0.05 | 0.65 | 1.10 | 0.26 | 0.27 | 0.005 | 0.009 | 0.0031 | 0.0043 | — | — |

| Steel | Component composition (% by mass) | | | | | | | |
|---|---|---|---|---|---|---|---|---|
| No. | B | W | Ni | Cu | REM | Others | 1.4 + V | Mo/V |
| AA | — | 0.30 | — | — | — | O: 0.0025 | 0.96 | 2.05 |
| AB | — | — | — | — | — | O: 0.0021 | 0.52 | 1.03 |
| AC | 0.0015 | — | — | — | — | O: 0.0014 | 0.93 | 2.93 |
| AD | — | — | — | — | — | O: 0.0012 | 0.46 | 0.83 |
| AE | — | — | — | — | — | O: 0.0016 | 0.46 | 1.67 |
| AF | — | — | — | — | — | O: 0.0017 | 0.44 | 0.27 |
| AG | — | — | — | — | — | O: 0.0021 | 1.01 | 3.30 |
| AH | — | — | — | — | — | O: 0.0012 | 1.03 | 3.13 |
| AI | — | — | 0.10 | — | — | O: 0.0011 | 1.19 | 2.75 |
| AJ | — | — | — | — | — | O: 0.0025 | 0.98 | 2.10 |
| AK | — | — | — | — | — | O: 0.0024 | 0.52 | 1.03 |
| AL | — | — | — | — | — | O: 0.0025 | 0.51 | 1.00 |
| AM | — | — | 0.01 | 0.01 | — | O: 0.0020 | 0.48 | 0.83 |
| AN | — | — | 0.01 | 0.01 | — | O: 0.0019 | 0.97 | 0.82 |
| AO | — | — | 0.01 | 0.01 | — | O: 0.0018 | 1.21 | 1.98 |
| AP | — | — | 0.01 | 0.01 | — | O: 0.0014 | 0.78 | 2.03 |
| AQ | — | — | — | — | — | O: 0.0015 | 0.78 | 1.71 |
| AR | — | — | — | — | — | O: 0.0031 | 0.53 | 0.71 |
| AS | — | — | — | — | — | O: 0.0020 | 0.62 | 1.21 |
| AT | — | — | — | — | — | O: 0.0019 | 1.83 | 5.00 |
| AU | — | — | — | — | — | O: 0.0021 | 0.59 | 0.51 |
| AV | — | — | — | — | — | O: 0.0025 | 0.46 | 0.96 |

Next, for reproducing manufacturing of a bolt, quenching and tempering were performed under the conditions listed in Table 2, and subsequently, the tensile strength and the trapped hydrogen concentration of each of the quenched and tempered bolt equivalents were measured, and the delayed fracture resistance was evaluated by the following methods.

(Quenching)

A round bar of 20 mm in diameter and 1000 mm in length obtained as described above was cut to obtain a round bar of 20 mm in diameter and 300 mm in length and quenched at the temperatures listed in Table 2. The retention time at the quenching heating temperature was set to 60 minutes. Subsequently, the bars were quenched in an oil bath maintained at 60° C.

(Tempering)

After oil quenching, tempering was performed at the temperatures listed in Table 2. The retention time at the tempering temperature was set to 60 minutes, and cooling after tempering was performed by air cooling (cooling rate 10° C./s).

(Tensile Test Piece)

A smooth tensile test piece (No. 14A test piece) with a total length of 70 mm, a parallel portion diameter of 6 mm, and a length of 32 mm was taken from a round bar with a diameter of 20 mm and a length of 300 mm after the quenching and tempering treatment described above.

(Preparation of Test Piece for Investigating Trapped Hydrogen Concentration)

From a round bar with a diameter of 20 mm and a length of 300 mm after the quenching and tempering treatment described above, a round bar test piece with a diameter of 7 mm and a length of 70 mm was taken and used as a round bar test piece for investigating the trapped hydrogen concentration.

(Preparation of Delayed Fracture Test Piece)

From a round bar of 20 mm in diameter and 300 mm in length after the above-described quenching and tempering treatment, a round bar test piece having a diameter of 7 mm and a length of 70 mm and having a notch (4.2 mm in diameter and 60° in angle at the notch) was taken and used as a delayed fracture test piece.

In this way, tensile test pieces of Manufacture Nos. 1 to 38, round bar test pieces for investigating the trapped hydrogen concentration of Manufacture Nos. 1 to 38, and delayed fracture test pieces of Manufacture Nos. 1 to 38 were obtained. With respect to Manufacture No. 32, subsequent tests were canceled because quenching cracking occurred. With respect to Manufacture Nos. 27, 28, 30, 31, and 33, subsequent tests were canceled because a predetermined strength was not achieved.

<Performance Evaluation Using Test Pieces >

(Number Density of MC-type Carbides with Length of 5 nm or More)

The number density (number per unit area of 0.01 μm²) of MC-type carbides with a length of 5 nm or more was measured as described above. The following criteria were used for evaluation.
A: The number density of MC-type carbides is from 10 per 0.01 μm² to less than 14 per 0.01 μm².
B: The number density of MC-type carbides is from 15 per 0.01 μm² to less than 20 per 0.01 μm².

C: The number density of MC-type carbides is from 20 per 0.01 μm² to less than 100 per 0.01 μm².
D: The number density of MC-type carbides is less than 10 per 0.01 μm².

(Tensile Strength)

The tensile strength was measured as described above.

Specifically, the tensile strength was determined by performing a tensile test in accordance with JIS Z 2241:2011 in the atmosphere at room temperature (25° C.), using a tensile test piece prepared by the procedure described above.

(Trapped Hydrogen Concentration)

The trapped hydrogen concentration was measured as described above.

Specifically, a round bar test piece of 7 mm in diameter and 70 mm in length prepared by the above-described procedure was subjected to a cathodic hydrogen charging for 72 hours at a current density of 0.2 mA/cm² in a solution at room temperature (25° C.) containing 3.0 g of ammonium thiocyanate per 1 L of 3.0% by mass sodium chloride aqueous solution. Subsequently, the test piece was left to stand at room temperature for 48 hours. After that, the temperature was raised from room temperature (25° C.) to 400° C. at a rate of 100° C./h and the amount of hydrogen released from the test sample was measured, using a gas chromatograph.

(Hydrogen Embrittlement Resistance)

The hydrogen embrittlement resistance was measured as described above.

Specifically, the delayed fracture test piece which had a diameter of 7 mm and a length of 70 mm and which had a notch (4.2 mm in diameter and 60° angle at the notch) and which was prepared by the above-described procedure was subjected to cathodic hydrogen charging for 24 hours at a current density of 0.03 mA/cm² in a solution at room temperature (25° C.) containing 3.0 g of ammonium thiocyanate per 1 L of 3.0% by mass sodium chloride aqueous solution, and then subjected to electro plating to prevent hydrogen evaporation (hot dip galvanizing), and left for 96 hours. Subsequently, a constant load that is 0.9 times the tensile strength was applied to the delayed fracture test piece, and the time until rupture occurred was measured. When the test piece did not rupture for 100 hours, the test was terminated.

Results of the tensile strength, the trapped hydrogen concentration, and the presence of delayed fracture are listed in Table 2. Underlined numerical values in Table 2 indicate that the corresponding values are outside the scope of the present disclosure. The sign “−” in Table 2 indicates that the corresponding fracture test piece was not subjected to the test because the test piece did not satisfy a predetermined strength or the like.

TABLE 2

| | | | | | | | | Number | |
|---|---|---|---|---|---|---|---|---|---|
| | | | | | | | | density of | |
| | | | | | | Hydrogen | | MC-type | |
| | | | | | | embrittlement | | carbides | |
| | | | | | | resistance | | with | |
| | | | | | Trapped | Presence | | equivalent | |
| | | | | Tensile | hydrogen | of | | diameter | |
| Manufacture | Steel | Quenching/ | Tempering/ | strength/ | concentration/ | delayed | Rupture | of 5 nm | |
| No. | No. | ° C. | ° C. | MPa | ppm | fracture | time/h | or more | Remark |
| 1 | A | 900 | 610 | 1,540 | 3.9 | None | >100 h | C | Example |
| 2 | B | 930 | 615 | 1,510 | 3.5 | None | >100 h | B | Example |
| 3 | B | 950 | 690 | 1,480 | 7.6 | None | >100 h | B | Example |
| 4 | C | 960 | 605 | 1,515 | 5.9 | None | >100 h | B | Example |
| 5 | D | 920 | 600 | 1,536 | 5.6 | None | >100 h | C | Example |
| 6 | E | 926 | 597 | 1,460 | 3.7 | None | >100 h | B | Example |
| 7 | F | 920 | 550 | 1,310 | 3.1 | None | >100 h | A | Example |
| 8 | G | 924 | 600 | 1,510 | 3.5 | None | >100 h | B | Example |
| 9 | H | 925 | 590 | 1,560 | 3.4 | None | >100 h | B | Example |
| 10 | I | 920 | 605 | 1,550 | 3.3 | None | >100 h | B | Example |
| 11 | J | 915 | 635 | 1,540 | 3.6 | None | >100 h | B | Example |
| 12 | K | 930 | 590 | 1,560 | 3.4 | None | >100 h | B | Example |
| 13 | L | 930 | 608 | 1,550 | 3.8 | None | >100 h | A | Example |
| 14 | H | 920 | 600 | 1,540 | 3.4 | None | >100 h | A | Example |
| 15 | I | 950 | 605 | 1,560 | 3.6 | None | >100 h | A | Example |
| 16 | B | 920 | 450 | 1,620 | 0.3 | Yes | 9 | D | Comparative Example |
| 17 | AA | 940 | 610 | 1,520 | 2.1 | Yes | 73 | D | Comparative Example |
| 18 | AB | 907 | 597 | 1,530 | 1.9 | Yes | 82 | D | Comparative Example |
| 19 | AC | 950 | 650 | 1,450 | 2.6 | Yes | 73 | B | Comparative Example |
| 20 | AD | 900 | 580 | 1,332 | 2.4 | Yes | 84 | D | Comparative Example |
| 21 | AE | 880 | 580 | 1,431 | 1.6 | Yes | 75 | D | Comparative Example |
| 22 | AF | 940 | 540 | 1,387 | 2.3 | Yes | 60 | D | Comparative Example |
| 23 | AG | 920 | 540 | 1,285 | 2.6 | Yes | 62 | D | Comparative Example |
| 24 | AH | 930 | 570 | 1,470 | 2.7 | Yes | 55 | D | Comparative Example |
| 25 | AI | 925 | 640 | 1,502 | 1.9 | Yes | 51 | D | Comparative Example |
| 26 | AJ | 906 | 603 | 1,498 | 1.8 | Yes | 56 | D | Comparative Example |
| 27 | AK | 936 | 600 | 1,175 | 3.5 | — | — | A | Comparative Example |
| 28 | AL | 930 | 595 | 1,180 | 2.3 | — | — | A | Comparative Example |
| 29 | AM | 920 | 605 | 1,390 | 3.2 | Yes | 76 | A | Comparative Example |
| 30 | AN | 890 | 600 | 1,190 | 2.1 | — | — | D | Comparative Example |
| 31 | AO | 890 | 610 | 1,180 | 2.7 | — | — | D | Comparative Example |
| 32 | AP | 950 | — | — | — | — | — | B | Comparative Example |
| 33 | AQ | 890 | 610 | 1,195 | 3.6 | — | — | B | Comparative Example |
| 34 | AR | 960 | 600 | 1,545 | 2.8 | Yes | 92 | B | Comparative Example |
| 35 | AS | 960 | 600 | 1,605 | 2.5 | Yes | 84 | D | Comparative Example |
| 36 | AT | 950 | 620 | 1,502 | 1.9 | Yes | 54 | D | Comparative Example |
| 37 | AU | 965 | 620 | 1,560 | 1.7 | Yes | 64 | D | Comparative Example |
| 38 | AV | 973 | 614 | 1,265 | 2.7 | Yes | 93 | D | Comparative Example |

As can be seen from Tables 1 and 2, Manufacture Nos. 1 to 15, in which the chemical composition and quenching and tempering conditions were optimized, all exhibited high tensile strength, high trapped hydrogen concentration, and no delayed fracture, demonstrating that excellent strength and delayed fracture resistance were obtained.

In contrast, Manufacture Examples Nos. 16 to 38, in which at least one of the chemical composition or quenching and tempering conditions was not optimized, were found to have neither excellent strength nor delayed fracture resistance.

The disclosure of Japanese Patent Application No. 2019-021904 is herein entirely incorporated by reference.

All publications, patent applications, and technical standards mentioned in the present specification are herein incorporated by reference to the same extent as if each individual publication, patent application, or technical standard was specifically and individually indicated to be incorporated by reference.

### INDUSTRIAL APPLICABILITY

According to the present disclosure, a bolt with high strength and exhibiting excellent delayed fracture resistance, and a steel material for a bolt to be used as the material for such a bolt can be provided.

1. A bolt having a composition comprising, in terms of % by mass:
C: from 0.35 to 0.45%,
Si: from 0.02 to 0.10%,
Mn: from 0.20 to 0.84%,
Cr: from 0.60 to 1.15%,
V: from 0.30 to 0.50%,
Mo: from 0.25 to 0.99%,
Al: from 0.010 to 0.100%,
N: from 0.0010 to 0.0150%,
P: 0.015% or less,
S: 0.015% or less, and
a balance consisting of Fe and impurities,
wherein the bolt has a tensile strength of from 1,200 MPa to less than 1,600 MPa, and
wherein the composition satisfies the following Formula (1) and the following Formula (2):
0.48≤Mo/1.4+V<1.10 (1)
0.80<Mo/V<3.00 (2)
wherein in Formula (1) and Formula (2), Mo and V represent contents (% by mass) of Mo and V contained in the bolt, respectively.

2. The bolt according to claim 1, further comprising at least one selected from the group consisting of:
Ti: 0.100% or less,
Nb: 0.100% or less,
B: 0.0050% or less,
Ni: 0.20% or less,
Cu: 0.20% or less,
W: 0.50% or less,
REM: 0.020% or less,
Sn: 0.20% or less, and
Bi: 0.10% or less.

3. The bolt according to claim 1, further comprising at least one selected from the group consisting of:
Pb: 0.05% or less,
Cd: 0.05% or less,
Co: 0.05% or less,
Zn: 0.05% or less,
Ca: 0.02% or less, and
Zr: 0.02% or less.

4. The bolt according to claim 1, wherein 10 or more MC-type carbides per unit area of 0.01 μm² that have a length of 5 nm or more and that contain a total of 70 atomic percent or more of V and Mo relative to M (metal element) are present.

5. The bolt according to claim 1, wherein the bolt exhibits a trapped hydrogen concentration of 3.0 ppm or more after the bolt is subjected to 72 hours of cathodic hydrogen charging at a current density of 0.2 mA/cm² in a solution at room temperature containing 3.0 g of ammonium thiocyanate per 1 L of 3.0% by mass sodium chloride aqueous solution, and then left to stand for 48 hours at room temperature.

6. The bolt according to claim 1, wherein, after the bolt is subjected to cathodic hydrogen charging for 24 hours at a current density of 0.03 mA/cm² in a solution at room temperature containing 3.0 g of ammonium thiocyanate per 1 L of 3.0% by mass sodium chloride aqueous solution, and then subjected to electro plating to prevent hydrogen evaporation and thereafter left to stand for 96 hours, a time that it takes for the bolt to rupture under a constant load that is 0.9 times the tensile strength is 100 hours or more.

7. A steel material for a bolt that is a material for the bolt according to claim 1, the steel material comprising the composition and the tensile strength of the bolt.

8. A steel material for a bolt that is a material for the bolt according to claim 2, the steel material comprising the composition and the tensile strength of the bolt.

9. A steel material for a bolt that is a material for the bolt according to claim 3, the steel material comprising the composition and the tensile strength of the bolt.
